(19) United States
(12) Patent Application Publication
(10) Pub. No.: US 2008/0165223 A1
(43) Pub. Date: Jul. 10, 2008

(54) Droplet Deposition Aparatus

(75) Inventors: Stephen Temple, Cambridge (GB); Paul R. Drury, Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XAAR TECHNOLOGY LIMITED, Cambridgeshire (GB)

(21) Appl. No.: 11/816,515

(22) PCT Filed: Feb. 27, 2006
(86) PCT No.: PCT/GB2006/000687

§ 371 Date: Sep. 18, 2007

(30) Foreign Application Priority Data
Feb. 26, 2005 (GB) 0503996.1

(51) Int. Cl. B41J 2/14; B41J 2/045

(52) U.S. Cl. 347/50; 347/68

(57) ABSTRACT

A component for a drop on demand printhead having three groups of actuators arranged on a surface forming a central group and two end groups. The electrical connections for the central group are split, one portion extending towards one edge of the surface in one direction, and the remaining portion extending towards an edge in a different direction. Such components can be butted together to form an array of such components providing improved actuator density along the module, and facilitating improved electrical connection.

The present invention relates to a printhead component, and in particular to the arrangement of actuators and electrical connections on that component.

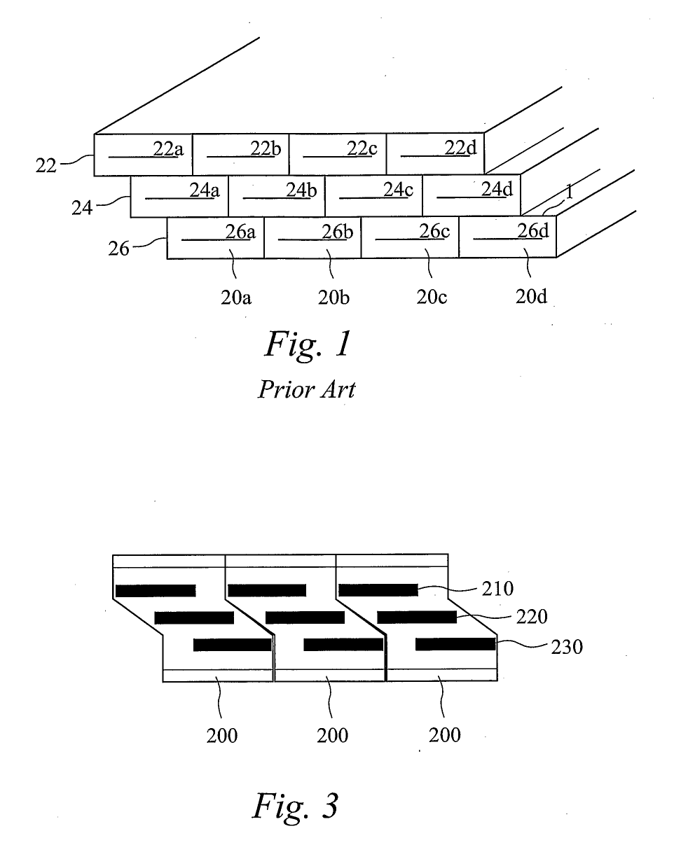

It has previously been proposed to construct a printhead from a number of printhead modules, one advantage being increased manufacturing yield. Such a construction is shown in FIG. 1, taken from EP 0339926, in which separable stacks 20a, 20b etc of laterally overlapping like modules 22a, 22b etc define three layers or surfaces 22, 24, 26.

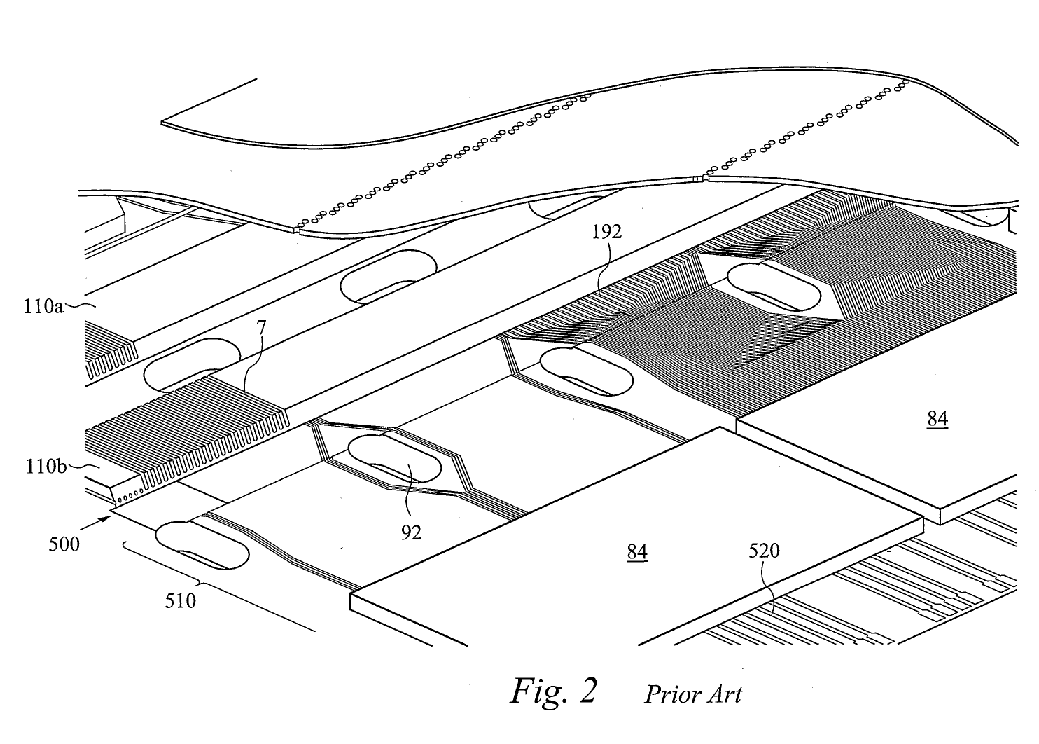

FIG. 2 is taken from WO 00/29217, and is a perspective exploded view of an inkjet printhead comprising strips 110a, 110b of poled piezoelectric material bonded to a substrate 86. Such an arrangement provides advantageous fluid handling capabilities, and improved ease of manufacture.

It is an object of one aspect of the present invention to provide an improved printhead component.

According to a first aspect of the invention there is provided a component for a drop on demand printhead comprising a mounting surface; three groups of actuators arranged on said surface, each group adapted to selectively eject fluid from a corresponding group of nozzles in response to an electric actuation signal, said groups spaced apart in a lateral direction thereby defining a central group and two end groups; electrical connections extending from said groups across said mounting surface, said connections allowing electric actuation signals to be applied to said actuators; wherein a first fraction of said electrical connections for said central group extend laterally away from said central group towards a first side of said surface, and wherein the remaining fraction of said electrical connections for said central group extend laterally away from said group towards a second side of said surface.

A second aspect of the invention provides a modular array of printhead components arranged along a module axis, each printhead component comprising a mounting surface; a central group of actuators arranged on said surface, and two end groups of actuators arranged on said surface, spaced apart from said central group perpendicular to said module axis; each group of actuators adapted to selectively eject fluid from a corresponding group of nozzles in response to an electric actuation signal; electrical connections extending from said groups across said mounting surface, said connections allowing electric actuation signals to be applied to said actuators; wherein a first fraction of said electrical connections for said central group extend away from said central group on a first side of said module axis, and wherein the remaining fraction of said electrical connections for said central group extend away from said group on the second side of said module axis.

The present invention will now be described by way of example only with reference to the accompanying drawings in which:

FIG. 1 illustrates a prior art arrangement of components stacked in a multi-layer arrangement

FIG. 2 shows a prior art printhead arrangement

FIG. 3 shows a modular array of print components according to an aspect of the present invention

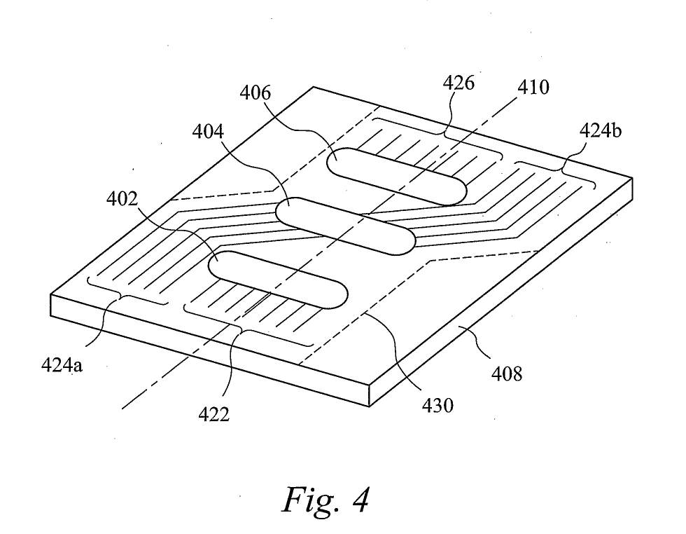

FIG. 4 illustrates a generalised printhead component according to an aspect of the present invention.

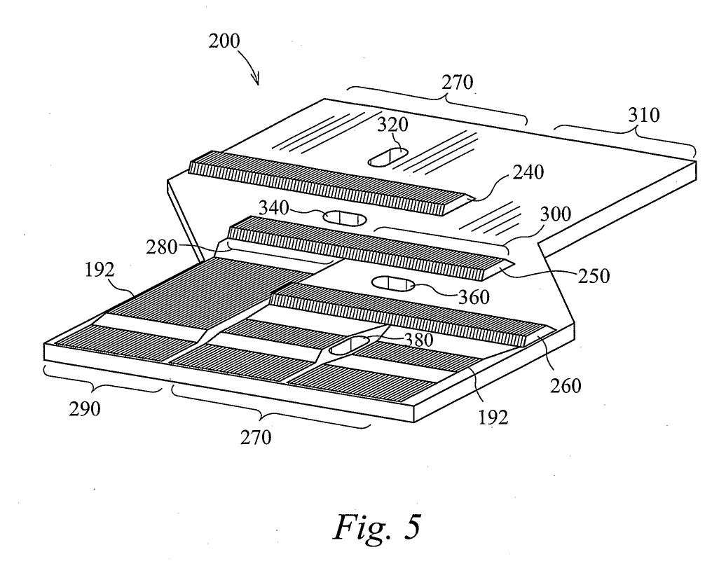

FIG. 5 is a perspective view of a component according to an aspect of the present invention.

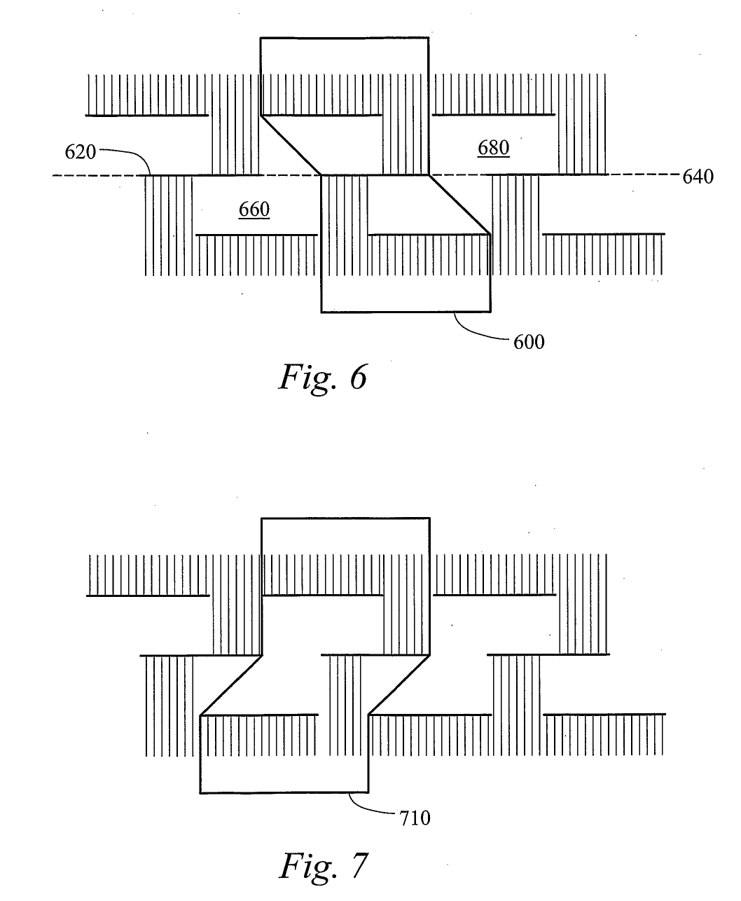

FIGS. 6 and 7 show modular arrays of components according to an aspect of the present invention

FIG. 3 shows a modular array of printhead components 200, each comprising three groups of actuators 210, 220, 230. In this embodiment, the groups are rows of channels, and such an arrangement avoids the complexity of butting rows of channels and allows any anomolous behaviour at the end of the channel row to be counteracted by means of adequate piezoelectric material at the end of that row.

FIG. 4 illustrates a generalised printhead component comprising three groups of actuators 402, 404, 406 arranged on a substrate 408. The three groups are spaced apart in a lateral direction 410. Electrical connections 422 for end group 402 extend away from the group directly towards the edge of the substrate as shown, and connections 426 for end group 406 extend in a similar fashion towards the opposite edge.

The connections for the central group 404 are split into two groups, one half of the connections 424a extend laterally towards one lateral edge of the substrate, passing to the side of end group 402. The remainder of the connections 424b extend towards the opposite lateral edge of the substrate. Again, these electrodes pass down one side of the respective end group. In this way, one side of the end groups remains free of electrodes, and the component can be arranged so as to position the end groups close to the edge of the substrate, as shown by dashed lines 430. This is advantageous when butting a plurality of substrates together.

The connections for the central group are shown advantageously originating from different sides of the group, however these connections may originate from any part of the central group

FIG. 5 shows a perspective view of the module 200 of FIG. 3 in greater detail. The construction is as per aforementioned WO 00129217, and will not be discussed in detail except to note that three strips of PZT 240, 250, 260 are used rather than two. Conductive tracks for the outer strips 240 and 260 are uniformly arranged along one side of the strip at 270. Tracks for the central strip 250 are split, those for half the strip 280 being arranged on one side of the strip and leading out to one side of the module as shown at 290, and those for the other half of the strip 300 being arranged on the other side of the strip and leading out to the other side of the module as shown at 310.

In order to supply ink to the actuators, holes 320, 340, 360, 380 are formed in the substrate, holes 320 and 360 arranged to supply ink to the actuators, and 340 and 380 arranged to receive ink from the actuators.

With reference to FIG. 6, a module 600 as per that shown in FIG. 5 is butted together with other like modules. It can be seen that if a module axis 640 is defined as being the axis along which one module is spaced from the next, then the arrangement of tracks as explained with reference to FIG. 5 results in half the tracks from the centre groups of actuators 620 extending towards one side of the module axis, and half of the tracks extending towards the other side of the module axis. This arrangement allows connection for all actuators to be achieved along the edges of the modular array, whilst at the same time preserving the track density along the edge of the array (ie that the track spacings are substantially the same for both centre groups and end groups) The arrangement also ensures that all points along the array are addressed by two groups of actuators, offering the possibility of increasing the actuator density along the module over the actuator density of the individual groups.

It can be seen that areas 660, 680 of the substrate are not occupied with tracks, and these areas can be used to provide ink feed holes, and also to align and/or secure the individual modules to form the array of modules, for example with the provision of alignment features.

FIG. 7 illustrates an alternative embodiment of a module 710 which achieves an array substantially the same as that shown in FIG. 6. The resulting array of modules has the same arrangement of actuator groups and tracks, but the tessellation of the modules is different. The module does not exhibit rotational symmetry as in FIG. 6, and the central group of actuators for each module has its tracks passing along the same butting edge of each module. In this way, the tracks for the central group are split, and each portion passes to one side of a respective end group, but in the opposite sense. In FIG. 7, the portions of tracks from the central group pass to the right of the respective end group on one side, and to the left of the respective end group on the other side, viewed looking outwards from the central group.

Whilst the example to tracks for the central group being split equally has been provided, the tracks may be split in different proportions. Although linear arrays of actuators have been described, groups of actuators may be arranged in other configurations.

1. A component for a drop on demand printhead comprising
a mounting surface;
three groups of actuators arranged on said surface, each group adapted to selectively eject fluid from a corresponding group of nozzles in response to an electric actuation signal, said groups spaced apart in a lateral direction thereby defining a central group and two end groups; and,
electrical connections extending from said groups across said mounting surface, said connections allowing electric actuation signals to be applied to said actuators;
wherein a first fraction of said electrical connections for said central group extend laterally away from said central group towards a first side of said surface, and wherein the remaining fraction of said electrical connections for said central group extend laterally away from said group towards a second side of said surface.

2. A component according to claim 1, wherein each fraction of said electrical connections for said central array pass to one side of a respective end group.

3. A component according to claim 1, wherein the electrical connections for one of said end groups extend away from said end group together with said first fraction of electrical connections for said central group, and the electrical connections for the other end group extend away from said other end group together with said second fraction of electrical connections for said central group.

4. A component according to claim 1, wherein each group of actuators comprises a linear array of actuators.

5. A component according to claim 4, wherein said linear arrays are substantially parallel.

6. A component according to claim 4, wherein said linear arrays are spaced apart perpendicular to said lateral direction.

7. A component according to claim 1, wherein said mounting surface comprises a substantially flat substrate.

8. A component according to claim 1, wherein said actuators comprise channels formed in a body of piezoelectric material.

9. A component according to claim 1, comprising feed holes in said substrate for passage of ejection fluid through said substrate.

10. A component according to claim 1, wherein said substrate is shaped to tessellate.

11. A component according to claim 10, wherein said substrate has two lateral edge portions, and two butting edge portions, said butting edge portions adapted to butt together with like modules, and said lateral edge portions adapted to provide electrical connection to said conductive tracks.

12. A modular array of components according to claim 10.

13. A modular array according to claim 12, the modules arranged along a module axis, said module axis being at an angle to said lateral direction.

14. A modular array according to claim 12, wherein said groups are arranged such that all points along the array axis are addressed by two groups of actuators.

15. A modular array according to claim 14, wherein the actuator density along the modular axis is twice the actuator density of each group of actuators along the modular axis.

16. A modular array of printhead components arranged along a module axis, each printhead component comprising:
a mounting surface;
a central group of actuators arranged on said surface, and two end groups of actuators arranged on said surface, spaced apart from said central group perpendicular to said module axis;
each group of actuators adapted to selectively eject fluid from a corresponding group of nozzles in response to an electric actuation signal; and
electrical connections extending from said groups across said mounting surface, said connections allowing electric actuation signals to be applied to said actuators;
wherein a first fraction of said electrical connections for said central group extend away from said central group on a first side of said module axis, and wherein the remaining fraction of said electrical connections for said central group extend away from said group on the second side of said module axis.

17. A modular array according to claim 16, wherein said electrical connections for said central group pass to one side of a respective end array.
